(19) United States
(12) Patent Application Publication
(10) Pub. No.: US 2006/0220447 A1
(43) Pub. Date: Oct. 5, 2006

(54) Method for the operation of a hydraulic brake system with an integrated parking brake function for motor vehicles

(76) Inventor: Berhard Giers, Bad Soden (DE)

Correspondence Address: Craig Hallacher;Continental Teves, One Continental Drive, Auburn Hills, MI, 48326, US

(21) Appl. No.: 10/552,687

(22) PCT Filed: Apr. 7, 2004
(86) PCT No.: PCT/EP04/50473

§ 371 Date: Oct. 11, 2005

(30) Foreign Application Priority Data
Apr. 8, 2003 (DE) 103 15 956.8

(51) Int. Cl. B60T 13/18

(52) U.S. Cl. 303/11

(57) ABSTRACT

Disclosed is a method for the operation of a hydraulic brake system with an integrated parking-brake function for motor vehicles having two vehicle axles. The system includes a pedal-operated pressure generator, at least one hydraulic pump, an operating element which is connected to an electronic control and regulation unit, and wheel brakes provided with inlet and outlet valves, with the wheel brakes associated with the second vehicle axle including a device for executing a parking-brake operation. To reduce noises caused by the hydraulic pump when initiating and terminating a parking-brake operation, the hydraulic pump is driven in such a fashion in the disclosed method that pressure build-up can be achieved at low noise.

### BACKGROUND OF THE INVENTION

The present invention relates to a method for the operation of a hydraulic brake system with an integrated parking-brake function for motor vehicles having two vehicle axles, said system substantially comprising a pedal-operated pressure generator, at least one hydraulic pump, an operating element which is connected to an electronic control and regulation unit, and wheel brakes provided with inlet and outlet valves, with the wheel brakes associated with the second vehicle axle including a means for executing a parking-brake operation.

U.S. Pat. No. 4,215,767 discloses a hydraulic vehicle brake with a parking-brake device of this type. To execute a parking-brake operation, it is provided in the prior art system that the pressure is built up in the operating pressure chamber by means of a hydraulic pump, whereby a brake piston is displaced that is lockable by way of a threaded-nut/spindle combination furnished with friction surfaces. Disturbing noise which develops during pressure build-up due to the hydraulic pump must be considered a disadvantage though.

### SUMMARY OF THE INVENTION

In view of the above, an object of the invention is to disclose a method for reducing noise that develops due to the hydraulic pump when pressure is built up for executing a parking-brake operation.

According to the method, this object is achieved by driving the hydraulic pump in such a fashion that the pressure which is necessary to initiate and/or terminate a parking-brake operation is built up with a minimum possible pressure-increase gradient. This provision achieves a low-noise pressure build-up.

In a particularly favorable improvement, the driving mode of the hydraulic pump is determined by the operator.

In this arrangement, a short actuation of the operating element by the operator is used to drive the hydraulic pump in such a fashion that the pressure required to execute a parking-brake operation is built up more slowly in the wheel brakes associated with the second axle than is the case with an actuation of the operating element over a long period of time.

It is provided in an especially favorable embodiment that the pressure that is introduced into the wheel brakes during a service brake phase is used to initiate a parking-brake operation.

In another favorable improvement of the method of the invention, at least the following steps are performed in the transition from a service-brake operation to a parking-brake operation:

Actuation of the operating element by the operator;

Closing the inlet valves of the wheel brakes associated with the first axle;

Pressure build-up performed by the hydraulic pump in the wheel brakes associated with the second axle;

Closing the inlet valves and opening the outlet valves of the wheel brakes associated with the second axle and activation of the means for performing a parking-brake operation.

### BRIEF DESCRIPTION OF THE DRAWINGS

The invention will be explained in detail in the following by way of an embodiment making reference to the accompanying drawings.

In the drawings:

FIG. 1 is a schematic circuit diagram of a hydraulic brake system allowing the implementation of the method of the invention;

FIG. 2 is an axial cross-sectional view of a hydraulic wheel brake for motor vehicles being employed on a vehicle axle in the brake system illustrated in FIG. 1.

### DETAILED DESCRIPTION OF THE DRAWINGS

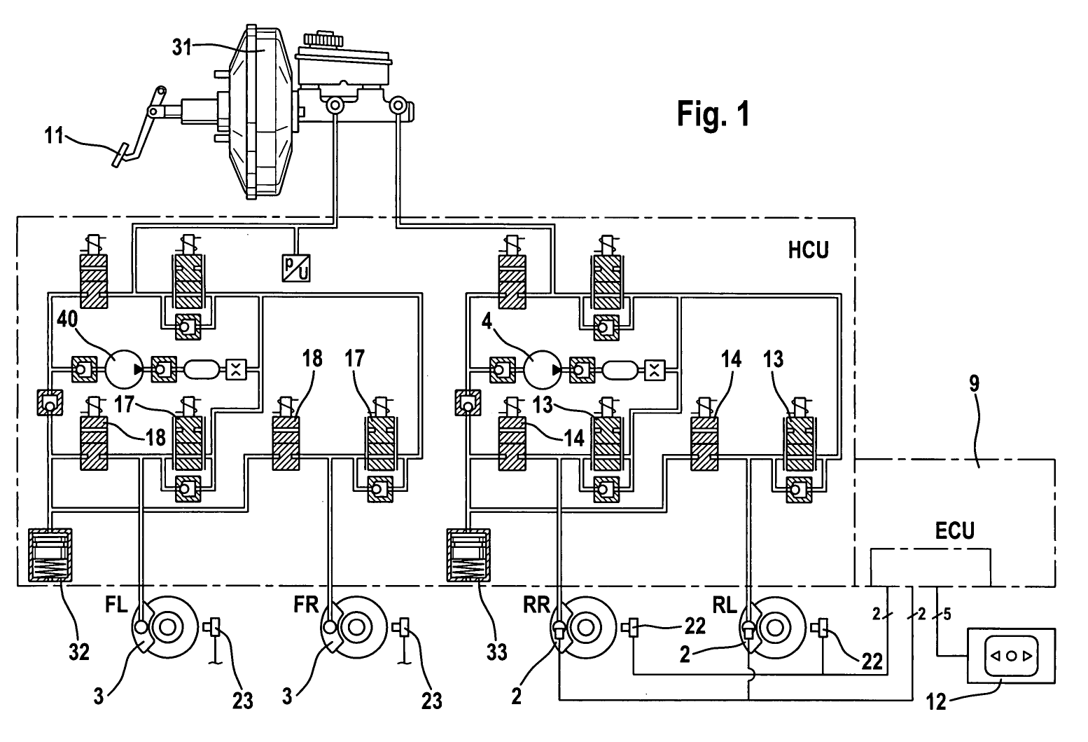

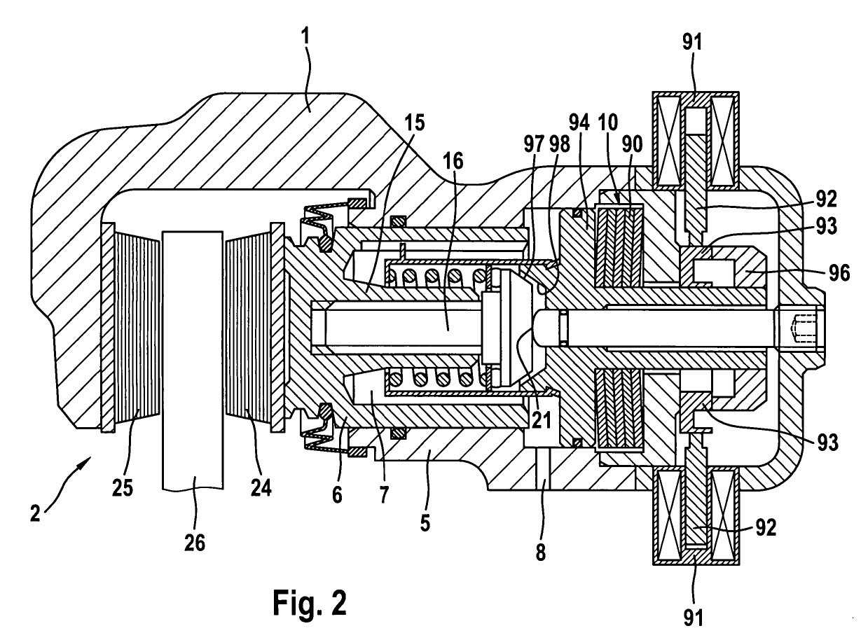

The circuit diagram of a brake system for motor vehicles represented in FIG. 1 is equipped with wheel brakes 3 on a first axle, the front axle, which do not include a locking device for executing a parking-brake operation, what is in contrast to further wheel brakes 2 on a second axle, the rear axle. The wheel brakes 2 with a locking device will be described in detail in the following by making reference to FIG. 2. By way of inlet valves 13, 17, the wheel brakes 2, 3 are pressurized by a pedal-operated pressure generator 31, which is illustrated in FIG. 1 as a vacuum brake booster with a subsequent master brake cylinder. The pressure reduction in the wheel brakes 2, 3 takes place by way of outlet valves 14, 18, whereby the brake fluid is supplied into low-pressure accumulators 32, 33. Besides, the brake system includes an electronic control and regulation unit 9 and a hydraulic pump 4, 40 for the wheel brakes 2, 3 on both vehicle axles, being jointly required for executing anti-lock control operations (ABS) and for control operations in the electronic stability program (ESP).

The hydraulic wheel brake 2 for motor vehicles illustrated in FIG. 2 has a brake housing 1 embracing the outside edge of a brake disc 26 and two brake pads 24, 25. In addition, the brake housing 1 includes a brake cylinder 5 receiving a brake piston 6 in an axially displaceable manner. Brake fluid is supplied by means of a hydraulic port 8 into the service pressure chamber 7 formed between brake cylinder 5 and brake piston 6, with the result that brake pressure develops which displaces the brake piston 6 in an axial direction towards the brake disc 26. This action urges the brake pad 24 facing the brake piston 6 against the brake disc 26, and the brake housing 1, in reaction thereto, displaces in the opposite direction, thereby urging also the other brake pad 25 against the brake disc 26.

The wheel brake 2 illustrated in the drawings includes a working storage 10 on the side of the brake housing 1 remote from the brake piston 6. Working storage 10 is mainly composed of an accumulator piston 94 bounding the service pressure chamber 7 and a spring element 90 and ensures that the application force acting on the brake pads 24, 25 during the parking-brake operation is almost independent of thermally induced length variations in the area of the brake housing 1. To achieve a parking-brake function, a means for locking the brake piston 6 is required, said means comprising a locking device configured as a threaded-nut/spindle arrangement and a first friction surface 98 on the accumulator piston 94. The threaded-nut/spindle arrangement, whose threaded nut 15 is designed integrally with the brake piston 6 includes a spindle 16 which is coupled to the threaded nut 15 by means of thread without self-locking engagement. Spindle 16 has a second friction surface 97 cooperating with the above-mentioned first friction surface 98 on the accumulator piston 94 when the brake piston 6 is locked.

There is further provision of an arresting unit which is arranged outside the working storage 10 and formed of two electromagnetic control members designed as electromagnets 91, the armatures 92 thereof being rigidly connected to an arresting element 23 designed as a slide. During service brake operations the accumulator piston 94 is blocked by the slide 93 because translational motion of a force-transmitting member 96 in the direction of the brake piston 6 is prevented, said member being rigidly connected to the accumulator piston 94. For this purpose, the force-transmitting member 96 is configured in such a fashion that it has two projections being received in recesses provided in the slide 93. The force-transmitting member 96 is prevented from moving in the direction of the brake piston 6 because the projections are supported on the slide 93. When the slide 93 is moved by the electromagnet 91 in such a fashion that the projections of the force-transmitting member 96 are in alignment with the recesses on the slide 93, the force-transmitting member 96 or the accumulator piston 94, respectively, can move in the direction of the brake piston 6.

To carry out a parking-brake operation, the hydraulic pump 4 mentioned with respect to FIG. 1 is used for the development of hydraulic pressure in the operating pressure chamber 7, said pressure causing the brake piston 6 to displace to the left in the drawing and the accumulator piston 94 to displace to the right in the drawing in opposition to the action of force of the spring element 90. After this displacement of the accumulator piston 94, the slide 93 is operable and can release the force-transmitting member 96. As soon as the hydraulic pressure is reduced after the actuation of the slide 93, the hydraulically preloaded spring element 90 brings about translational motion of the accumulator piston 94 in the direction of the brake piston 6 until the friction surfaces 97, 98 are in engagement, whereby the brake piston 6 adopts a locked condition. As this occurs, the spindle 16 lifts from the central bearing 21, and the spring element 90 acts by means of the closed flux of forces from the accumulator piston 94 via the threaded-nut/spindle arrangement to the brake piston 6 and generates the application force required to perform the parking-brake operation. To terminate the parking-brake operation, the above-mentioned hydraulic pump 4 is used again to develop hydraulic pressure in the operating pressure chamber 7 and the accumulator piston 94 in FIG. 2 is displaced to the right, while the spring element 90 is hydraulically preloaded. As the effective diameter of the accumulator piston 94 is chosen to be greater than the effective diameter of the brake piston 6, the activation pressure for performing a parking-brake operation is reduced. Subsequently, the accumulator piston 94 is blocked again by the slide 93 by means of the force-transmitting member 96.

The method of the invention described hereinbelow by way of FIG. 1 provides that the hydraulic pump 4 is driven in such a fashion that the pressure required to initiate and terminate a parking-brake operation is built up at low noise. To this end, the necessary pressure is built up by the hydraulic pump 4 with a minimum possible pressure increase gradient predetermined by the structural features of the hydraulic pump 4. The pressure increase gradient implies the time gradient of the rate of delivery of the hydraulic pump 4. When this pressure increase gradient is selected to be sufficiently low, the noise produced by the hydraulic pump 4 is no longer noticeable for the operator in the interior of the motor vehicle. Unless the operator maintains the vehicle being at standstill in a safe condition using the service brake, that means by depression of the brake pedal 11, upon actuation of the operating element 12 by the operator, the pressure in the wheel brakes 2 associated with the rear axle is initially built up with a maximum possible pressure increase gradient predetermined by the structural features of the hydraulic pump 4, with the outlet valves 14 closed simultaneously. This is done until the brake pistons 6 of the wheel brakes 2 described with respect to FIG. 2 generate an amount of application force that is sufficient for the safe standstill of the motor vehicle. The pressure necessary for a sufficient amount of application force is determined either by means of an acceleration sensor (not shown in FIG. 1) or, in the absence of an acceleration sensor, by a pressure value chosen to be sufficiently high. Subsequently, the hydraulic pump 4 builds up the pressure that is additionally required by means of the above-mentioned minimum pressure gradient until the accumulator piston 94 described by means of FIG. 2 has been displaced sufficiently far and the slide 93 can release the force-transmitting member 96 and, hence, the accumulator piston 94. Closing of the inlet valves 13 and opening of the outlet valves 14 will cause engagement of the friction surfaces 97, 98 described hereinabove, and the brake pistons 6 of the wheel brakes 2 of the rear axle are locked in an applied condition by the effect of the spring assembly 90, as has been described already by way of FIG. 2.

Further, the method of the invention provides that the driving mode of the hydraulic pump 4 is determined by the operator. With a short activation of the operating element 12 by the operator, the hydraulic pump 4 is driven in such a way that the pressure required for introducing and terminating a parking-brake operation is built up slowly, that means with a low pressure increase gradient. The pressure increase can be stopped by a continued activation of the operating element 12. As has been mentioned already, the noise produced by the hydraulic pump 4 cannot be noticed by the operator due to the slow pressure increase. In case the operator desires a rapid pressure increase to introduce or terminate a parking-brake operation, he/she is required to activate the operating element 12 longer, that means preferably longer than 3 seconds. Thereafter, the necessary pressure is built up with a maximum possible pressure increase gradient predetermined by the structural features of the hydraulic pump 4. In an alternative of the method of the invention, the pressure increase gradient is linearly linked to the activation time of the operating element 12. This provision allows the operator to handle the speed of the pressure build-up independently.

Furthermore, it is provided in the described method that the pressure introduced into the wheel brakes 2, 3 of the rear and the front axles during a service brake operation is used to initiate a parking-brake operation. The basic situation is that the operator uses the service brake to bring the vehicle to standstill. To do so, the operator applies the brake pedal 11, whereupon pressure is built up in the wheel brakes 2, 3. After the operator has brought the motor vehicle to standstill, he usually continues depressing the brake pedal 11. The inlet valves 17 of the wheel brakes associated with the front axle are closed and the pressure introduced during the service brake operation is shut in the wheel brakes 3 of the front axle after the operator has actuated the operating element 12. Thereafter follows a slow pressure build-up by way of the hydraulic pump 4 into the wheel brakes 2 of the rear axle until the accumulator piston 94 described already by way of FIG. 2 or the force-transmitting member 96, respectively, have been displaced to the right in FIG. 2. The slide 93 is then moved out of its position blocking the accumulator piston 94. When subsequently the inlet valves 13 of the wheel brakes 2 are closed and the outlet valves 14 opened, the accumulator piston 94 will move to the right in FIG. 2, whereupon the friction surfaces 97, 98 are moved into engagement with each other. The effect of the spring element 90 described already hereinabove applies the brake piston 6 and thus the two brake pads 24, 25 to the brake disc 26. The means for executing a parking-brake operation is thus activated. The pressure introduced into the wheel brakes 2, 3 during a service brake operation is used by the previously described method to initiate a parking-brake operation.

1-5. (canceled)

6. A method for operating a hydraulic brake system having an integrated parking-brake function for motor vehicles having at least two vehicle axles, the system including a pedal-operated pressure generator (31), at least one hydraulic pump (4), an operating element (12) which is connected to an electronic control and a regulation unit (9), and wheel brakes (2, 3) provided with inlet and outlet valves (13, 14, 17, 18), with the wheel brakes (2) associated with the second vehicle axle including a device for executing a parking-brake operation, the method comprising:
driving the hydraulic pump (4) in such a fashion that a pressure that is necessary to initiate or terminate a parking-brake operation is built up with a minimum possible pressure-increase gradient.

7. The method according to claim 6, wherein an operator determines a driving mode of the hydraulic pump.

8. The method according to claim 7, wherein when the operating element (12) is shortly actuated by the operator, the hydraulic pump (4) is driven in such a fashion that the pressure required to execute a parking-brake operation is built up more slowly in the wheel brakes (2) associated with the second axle than is the case with an actuation of the operating element (12) over a long period of time.

9. The method according to claim 6, wherein the pressure that is introduced during a service brake phase in the wheel brakes (2, 3) is used to initiate a parking-brake operation.

10. The method according 9, wherein at least the following steps are performed in the transition from a service-brake operation to a parking-brake operation:
I. Actuation of the operating element (12) by the operator;
II. Closing the inlet valves (17) of the wheel brakes (3) associated with the first axle;
III. Pressure build-up performed by the hydraulic pump (4) in the wheel brakes (2) associated with the second axle;
IV. Closing the inlet valves (13) and opening the outlet valves (14) of the wheel brakes (2) associated with the second axle and activation of the means for performing a parking-brake operation.
